(19) United States
(12) Patent Application Publication
(10) Pub. No.: US 2023/0359556 A1
(43) Pub. Date: Nov. 9, 2023

(54) Performing Operations for Handling Data using Processor in Memory Circuitry in a High Bandwidth Memory

(71) Applicant: Advanced Micro Devices, Inc., Santa Clara, CA (US)

(72) Inventors: Jagadish B. Kotra, Austin, TX (US); Marko Scrbak, Austin, TX (US)

(21) Appl. No.: 17/735,469

(22) Filed: May 3, 2022

(51) Int. Cl. G06F 12/0802

(52) U.S. Cl. CPC G06F 12/0802; G06F 2212/60

(57) ABSTRACT

An electronic device includes a processor and a memory separate from the processor. The memory includes memory circuitry including a plurality of locations and processor in memory circuitry. In some implementations, some or all of the locations are used for storing cache blocks for a cache memory and the processor in memory circuitry performs operations for handling cache blocks in the memory circuitry. In some implementations, some or all of the locations are used for storing data for a memory and the processor in memory circuitry performs operations for handling data in the memory circuitry.

### BACKGROUND

### Related Art

Some electronic devices include processors (e.g., central processing units, etc.) that use data (e.g., program code instructions, inputs for or results of computational or control operations, etc.) for processor operations. Many of these electronic devices also include a non-volatile mass storage such as a disk drive or larger-capacity semiconductor memory that is used for long-term storage for the data used by processors. Because accessing data (i.e., reading, writing, etc.) in mass storages is relatively slow, many electronic devices also include a memory (e.g., a main memory) in which copies of data are stored for use by the processors for processor operations. Accessing a copy of data in a memory is significantly faster than accessing the data in a mass storage, but many processors perform operations quickly enough that the processors may need to wait for data to be accessed even in memories. Electronic devices often therefore also include one or more cache memories, which are smaller-capacity, faster-access memories in which copies of data are stored for use by the processors. For example, in some electronic devices, caches are implemented in static random access memory (SRAM) fabricated on the processor itself near processing circuitry that uses the data, which can make accesses very fast. Because SRAM is complex and expensive to implement in comparison to other forms of memory circuitry—particularly on area-constrained processor dies—SRAM caches have traditionally been limited in storage capacity.

Some electronic devices include high-bandwidth memories (HBM), which are memories external to processor dies. High bandwidth memories are connected to processors via high-speed interfaces, which means that accessing data in high bandwidth memories can be fast, despite the fact that the high bandwidth memories are often implemented using slower-access memory circuitry such as dynamic random access memory (DRAM). Along with being fast enough to be used as part of operating system visible memory (i.e., as part of a main memory), high bandwidth memories are sufficiently fast to access to enable high bandwidth memories to be used as cache memories for storing copies of data for processors. In other words, high bandwidth memories (or portions thereof) can be employed as caches, or “high bandwidth memory caches,” situated in a memory hierarchy between the memory and higher-level on-die cache memories. Although high bandwidth memories can be used as caches, using a high bandwidth memory as a cache requires a processor to perform at least some cache operations via the interface to the high bandwidth memory. In other words, cache operations that have traditionally been performed for on-die SRAM caches at higher speeds must now be performed for the external high bandwidth memory caches at lower speeds. For example, given high bandwidth memory's higher capacity, the large number of tags (or other identifiers) and metadata associated with cache blocks stored in high bandwidth memory caches are typically not stored on the processor itself, but instead are stored on the high bandwidth memory. For operations such as cache lookups, coherency updates, etc., the processor must therefore access the tags and/or metadata in the high bandwidth memory via the interface. Performing these cache operations via the interface to the high bandwidth memory is a bottleneck in the performance of high bandwidth memory caches.

### BRIEF DESCRIPTION OF THE FIGURES

FIG. 1 presents a block diagram illustrating an electronic device in accordance with some implementations.

FIG. 2 presents a block diagram illustrating a high bandwidth memory in accordance with some implementations.

FIG. 3 presents an isometric view of a processor and a high bandwidth memory in accordance with some implementations.

FIG. 4 presents a block diagram illustrating memory circuitry in a high bandwidth memory used as a cache memory in accordance with some implementations.

FIG. 5 presents a block diagram illustrating memory circuitry in a high bandwidth memory used as operating system visible memory in accordance with some implementations.

FIG. 6 presents a flowchart illustrating a process for handling cache blocks in memory circuitry in a high bandwidth memory by processor in memory circuitry in accordance with some implementations.

FIG. 7 presents a flowchart illustrating a process for handling accesses of cache blocks in a memory by processor in memory circuitry in accordance with some implementations.

FIG. 8 presents a block diagram illustrating locations in memory circuitry and corresponding ECC bits in accordance with some implementations.

FIG. 9 presents a flowchart illustrating a process for swapping cache blocks in a memory by processor in memory circuitry in accordance with some implementations.

FIG. 10 presents a flowchart illustrating a process for handling dead cache blocks in a memory by processor in memory circuitry in accordance with some implementations.

FIG. 11 presents a flowchart illustrating a process for compressing data in cache blocks in a memory by processor in memory circuitry in accordance with some implementations.

FIG. 12 presents a flowchart illustrating a process for handling operating system visible data in memory circuitry in a high bandwidth memory by processor in memory circuitry in accordance with some implementations.

FIG. 13 presents a flowchart illustrating a process for handling memory scrubbing of data in a high bandwidth memory by processor in memory circuitry in accordance with some implementations.

Throughout the figures and the description, like reference numerals refer to the same figure elements.

### DETAILED DESCRIPTION

The following description is presented to enable any person skilled in the art to make and use the described implementations and is provided in the context of a particular application and its requirements. Various modifications to the described implementations will be readily apparent to those skilled in the art, and the general principles described herein may be applied to other implementations and applications. Thus, the described implementations are not limited to the implementations shown, but are to be accorded the widest scope consistent with the principles and features described herein.

### Terminology

In the following description, various terms are used for describing implementations. The following is a simplified and general description of some of the terms. Note that these terms may have significant additional aspects that are not recited herein for clarity and brevity and thus the description is not intended to limit these terms.

Functional block: functional block refers to a set of interrelated circuitry such as integrated circuit circuitry, discrete circuitry, etc. The circuitry is “interrelated” in that circuit elements in the circuitry share at least one property. For example, the circuitry may be included in, fabricated on, or otherwise coupled to a particular integrated circuit chip, substrate, circuit board, or portion thereof, may be involved in the performance of specified operations (e.g., computational operations, control operations, memory operations, etc.), may be controlled by a common control element and/or a common clock, etc. The circuitry in a functional block can have any number of circuit elements, from a single circuit element (e.g., a single integrated circuit logic gate or discrete circuit element) to millions or billions of circuit elements (e.g., an integrated circuit memory). In some implementations, functional blocks perform operations “in hardware,” using circuitry that performs the operations without executing program code.

Data: data as used herein is a generic term that indicates information that can be stored in memories (e.g., a main memory, a cache memory, etc.) and/or used in computational, control, and/or other operations. Data includes information such as actual data (e.g., results of computational or control operations, outputs of processing circuitry, inputs for computational or control operations, variable values, sensor values, etc.), files, program code instructions, control values, variables, metadata, and/or other information.

Memory accesses: memory accesses, or, more simply, accesses, include interactions that can be performed for, on, using, and/or with data stored in memory. For example, accesses can include writes or stores of data to memory, reads of data in memory, invalidations or deletions of data in memory, moves of data in memory, writes or reads of metadata associated with data in memory, etc. In some cases, copies of data are accessed in a cache and accessing the copies of the data can include interactions that can be performed for, on, using, and/or with the copies of the data stored in the cache (such as those described above), along with cache-specific interactions such as updating coherence or access permission information, etc. In some cases, accesses of data in memories and/or cache memories are or include accesses of metadata associated with the data, such as validity information, coherence information, permissions information, etc.

### Overview

In the described implementations, an electronic device includes a processor that uses data for performing various operations (e.g., executing program code, performing control or configuration operations, etc.) and a non-volatile mass storage for longer-term storage of data. The electronic device also includes a memory hierarchy having a memory (e.g., a main memory) and a number of cache memories used for storing copies of data retrieved from the mass storage for faster accesses by the processor. For example, in some implementations, the memory is fabricated on one or more semiconductor dies external to a package in which a semiconductor die of the processor is enclosed (e.g., a pin grid array package) and the cache memories include level one through level three (L1-L3) cache memories fabricated on the same semiconductor die as the processor. The electronic device additionally includes a high bandwidth memory (HBM) that is also used for storing copies of data for the processor. For example, in some implementations, the high bandwidth memory includes one or more semiconductor dies having memory circuitry fabricated thereon that are enclosed in the package with the processor semiconductor die. The high bandwidth memory is connected to the processor via a high speed interface that enables the processor to access data in the high bandwidth memory rapidly—and typically faster than the processor is able to access data in the memory.

In the described implementations, the high bandwidth memory includes processor in memory (PIM) circuitry that performs operations on, using, and/or for data and/or associated metadata in the high bandwidth memory. Generally, the processor in memory circuitry includes access circuitry for accessing data and/or associated metadata in the memory circuitry and processing circuitry (e.g., logic circuitry, control circuitry, etc.) for performing the operations on, using, and/or for the data and/or the associated metadata. For example, in some implementations, the processing circuitry can perform logical, bitwise, mathematical, and/or other operations on, using, and/or for data and/or the associated metadata. In some implementations, the processor in memory circuitry is able to acquire data and/or metadata from the memory circuitry or receive the data and/or metadata from another source (e.g., the processor, etc.) and perform operations on the data and/or metadata in the processor in memory circuitry, so that the data and/or metadata remains “on the memory.” The data and/or metadata is therefore not sent to the processor and/or another entity to have the operations performed thereon. In some implementations, the processor in memory circuitry initiates specified operations, so that the processor in memory circuitry performs the operations without receiving commands from other entities, such as the processor. In some implementations, processor (and/or another entity) communicates commands to the processor in memory circuitry to cause the processor in memory circuitry to perform specified operations. In this way, the processor can “offload” specified operations to the processor in memory circuitry—and avoid the processor needing to perform these operations itself.

In some implementations, some or all of the memory circuitry in the high bandwidth memory is used as a cache memory or “cache,” i.e., a high bandwidth memory cache. In these implementations, locations in the memory circuitry in the high bandwidth memory are used for storing cache blocks (e.g., 64 byte cache lines, etc.) that are received from the processor, the memory, and/or the mass storage, as well as metadata for the cache blocks (e.g., tags/identifiers, coherency information, access information, etc.). For example, in some implementations, the high bandwidth memory cache is part of the above-described hierarchy of caches and functions as a lowest cache in the hierarchy (e.g., is an L4 cache in a hierarchy with the L1-L4 caches). In some implementations, the high bandwidth memory cache is organized as set associative, so that the respective memory circuitry is logically divided into a number of sets, with each set being used for storing copies of cache blocks from a given range of memory addresses, and a number of ways in each set that are used for storing individual cache blocks. In some implementations, the operations performed by the processor in memory circuitry include operations for handling cache blocks in the high bandwidth memory cache. That is, the processor in memory circuitry performs operations associated with using the memory circuitry in the high bandwidth memory as a cache memory—thereby avoiding the need for the processor (and/or other entities) to perform some or all of the operations for handling the cache blocks. The operations for handling the cache blocks performed by the processor in memory circuitry include operations associated with one or more of: storing cache blocks in locations in the memory circuitry of the high bandwidth memory, accessing cache blocks in locations in the memory circuitry on behalf of the processor (and/or other entities), managing cache blocks in the memory circuitry, etc. For example, in some implementations, among the operations for handling the cache blocks are one or more of: performing lookups to determine if cache blocks are present in the high bandwidth memory cache, accessing data in cache blocks in the high bandwidth memory cache, handling misses during lookups for cache blocks in the high bandwidth memory cache, maintaining access information and/or other metadata for cache blocks in the high bandwidth memory cache, swapping hot cache blocks to desired locations in sets in the high bandwidth memory cache, identifying and invalidating dead cache blocks in the high bandwidth memory cache, and/or compressing data in cache blocks in the high bandwidth memory cache.

In some implementations, some or all of the memory circuitry in the high bandwidth memory is used as part of/an extension of an operating system (OS) visible memory in the electronic device. For example, in some of these implementations, some or all of the memory circuitry in the high bandwidth memory is used as part of/an extension of a “main” memory in the electronic device. In these implementations, the overall addressable space of the memory, and thus the locations where data can be stored in the memory, includes locations in the memory circuitry of the high bandwidth memory in addition to locations in the above-described memory. In some implementations, the operations performed by the processor in memory circuitry include operations for handling data in the memory circuitry in the high bandwidth memory that is used as part of the OS visible memory. That is, the processor in memory circuitry performs operations associated with using the memory circuitry in the high bandwidth memory as part of the OS visible memory—thereby avoiding the need for the processor (and/or other entities) to perform some or all of the operations for handling the data. For example, in some implementations, the operations for handling the data include memory scrubbing operations for correcting bit errors in data stored in locations in the memory circuitry in the high bandwidth memory using error correction information stored in respective metadata. As another example, in some implementations, the operations for handling the data include performing lookups in a remapping table for locations (e.g., physical addresses) of data that may have been migrated between the main memory and the high bandwidth memory.

By using the processor in memory circuitry to perform the operations for handling cache blocks in the high bandwidth memory cache and/or perform the operations for handling data in the OS visible memory, the described implementations can avoid the need for the processor (and/or other entities) to perform these operations. This can help to reduce traffic on memory buses, memory access latency, operational load on the processor, heat generation, etc., which can improve the performance of the processor and the electronic device. Improving the performance of the electronic device increases user satisfaction with the electronic device.

### Electronic Device

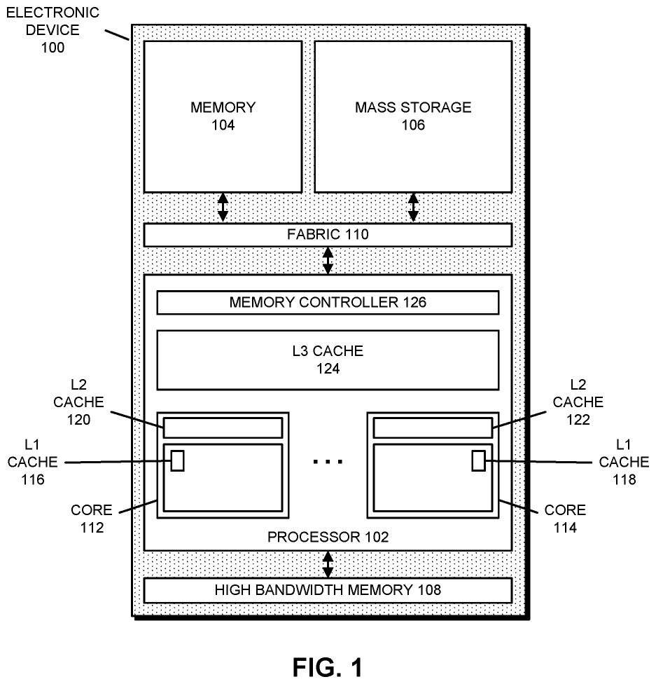

FIG. 1 presents a block diagram illustrating an electronic device 100 in accordance with some implementations. As can be seen in FIG. 1, electronic device 100 includes processor 102, memory 104, mass storage 106, high bandwidth memory 108, and fabric 110. Generally, processor 102, memory 104, mass storage 106, high bandwidth memory 108, and fabric 110 are implemented in hardware, i.e., using corresponding integrated circuitry, discrete circuitry, and/or devices. For example, in some implementations, processor 102, memory 104, mass storage 106, high bandwidth memory 108, and fabric 110 are implemented in integrated circuitry on one or more semiconductor chips, are implemented in a combination of integrated circuitry on one or more semiconductor chips in combination with discrete circuitry and/or devices, or are implemented in discrete circuitry and/or devices. In some implementations, processor 102, memory 104, mass storage 106, high bandwidth memory 108, and/or fabric 110 perform operations for, dependent on, or associated with handling data and/or metadata in high bandwidth memory 108 as described herein.

Processor 102 is a functional block that performs computational, memory access, control, and/or other operations. For example, processor 102 can be a central processing unit (CPU), a graphics processing unit (GPU), an accelerated processing unit (APU), a system on a chip (SOC), a field programmable gate array (FPGA), etc. Processor 102 includes a number of cores 112-114. Each of cores 112-114 is a separate functional block that performs computational, memory access, control, and/or other operations. For example, in some implementations, each of cores 112-114 is or includes a central processing unit (CPU) core, a graphics processing unit (GPU) core, an embedded processor, an application specific integrated circuit (ASIC), a microcontroller, and/or another functional block.

Memory 104 is a functional block that stores data for accesses by other functional blocks in electronic device 100. For example, in some implementations, memory 104 is a higher capacity integrated circuit memory in which copies of data retrieved from mass storage 106 are stored for subsequent accesses by the other functional blocks (e.g., cores 112-114, etc.). Memory 104 includes memory circuitry such as fifth generation double data rate synchronous dynamic random-access memory (DDR5 SDRAM) and/or other types of memory circuitry, as well as control circuitry for handling accesses of the data stored in the memory circuitry. In some implementations, memory 104 is what has traditionally been regarded as a “main” memory in electronic device 100.

Mass storage 106 is a functional block, device, and/or element including a non-volatile memory for longer-term storage of data for use by other functional blocks in electronic device 100. For example, mass storage 106 can be or include one or more non-volatile semiconductor memories, hard disks, optical disks, magnetic tapes, etc. As described above, copies of data are retrieved from mass storage 106 and stored in memory 104 for access by the other functional blocks.

Returning to processor 102, processor 102 includes cache memories, or “caches,” which are functional blocks that are used for storing copies of data that can be used by cores 112-114 (and/or other entities) for performing various operations. For example, the caches can be used to store cache blocks such as M-byte cache lines (or combinations or portions of cache lines) that include copies of data retrieved from memory 104 and/or mass storage 106 (M=64, 128, or another number). As can be seen in FIG. 1, the caches include level one caches 116-118 (L1 CACHE 116 and L1 CACHE 118) and level two caches 120-122 (L2 CACHE 120 and L2 CACHE 122) in cores 112-114, respectively. Each of L1 caches 116-118 and L2 caches 120-122 includes memory circuitry for storing cache blocks with copies of data and control circuitry for handling accesses of data stored in the memory circuitry. The caches also include a level three cache 124 (L3 CACHE 124) that includes memory circuitry for storing cache blocks with copies of data and control circuitry for handling accesses of data stored in the memory circuitry. In some implementations, L3 cache 124 is shared by cores 112-114 and therefore can be used for storing copies of data that can be accessed by both of cores 112-114. In some implementations, the caches considered a hierarchy, with smaller and faster-access caches higher in the hierarchy.

For example, in some implementations, the highest caches in the hierarchy, L1 caches 116-118, are 128 KiB and are the fastest to access, L2 caches 120-122 are 1024 KiB and are accessed at an intermediate speed, and the lowest cache in the hierarchy, L3 cache 124, is 64 MiB and is the slowest to access. In some implementations, L1 caches 116-118 are split into separate data and instruction caches.

Processor 102 also includes memory controller 126, which is a functional block that performs operations for interfacing between processor 102 and memory 104. Memory controller 126 performs operations such as synchronizing memory accesses, detecting and avoiding conflicts between memory accesses, directing data accessed during memory accesses to or from particular functional blocks in electronic device 100 (e.g., cores 112-114), etc.

High bandwidth memory 108 is a functional block that stores copies of data for accesses by other functional blocks in electronic device 100 (e.g., cores 112-114, etc.). For example, in some implementations, high bandwidth memory 108 is an integrated circuit memory in which copies of data retrieved from mass storage 106 or received from functional blocks on processor 102 are stored for subsequent accesses by the other functional blocks. High bandwidth memory 108 includes memory circuitry such as DDR5 SDRAM and/or other types of memory circuitry, as well as control circuitry for handling accesses of the data stored in the memory circuitry. The memory circuitry in high bandwidth memory 108 can be used in various ways depending on the implementation, including as a cache memory and/or an additional portion of memory circuitry for memory 104. High bandwidth memory 108 is described in more detail below.

Fabric 110 is a functional block that performs operations for communicating data between other functional blocks in electronic device 100 via one or more communication channels. Fabric 110 includes wires/traces, transceivers, control circuitry, etc., that are used for communicating the data in accordance with a protocol or standard in use on fabric 110. For example, in some implementations, fabric 110 is or includes an Infinity Fabric from Advanced Micro Devices Inc. of Santa Clara, CA.

Although electronic device 100 is shown in FIG. 1 with a particular number and arrangement of functional blocks and devices, in some implementations, electronic device 100 includes different numbers and/or arrangements of functional blocks and devices. For example, in some implementations, electronic device 100 includes a different number of processors. In addition, although processor 102 is shown with a given number and arrangement of functional blocks, in some implementations, processor 102 includes a different number and/or arrangement of functional blocks. For example, in some implementations, processor 102 includes a different number of cores and/or a different number and/or arrangement of cache memories. Generally, in the described implementations, electronic device 100 and processor 102 include sufficient numbers and/or arrangements of functional blocks to perform the operations herein described. Electronic device 100 as shown in FIG. 1 is simplified for illustrative purposes. In some implementations, however, electronic device 100 includes additional or different elements (i.e., functional blocks and devices) for performing the operations herein described and other operations. For example, electronic device 100 can include electrical power functional blocks or devices, human interface functional blocks or devices (e.g., displays, touch sensitive input elements, speakers, etc.), input-output functional blocks or devices, etc.

Electronic device 100 can be, or can be included in, any electronic device that performs memory operations such as those described herein. For example, electronic device 100 can be, or can be included in, desktop computers, laptop computers, wearable electronic devices, tablet computers, smart phones, servers, artificial intelligence apparatuses, virtual or augmented reality equipment, network appliances, toys, audio-visual equipment, home appliances, controllers, vehicles, etc., and/or combinations thereof.

### High Bandwidth Memory

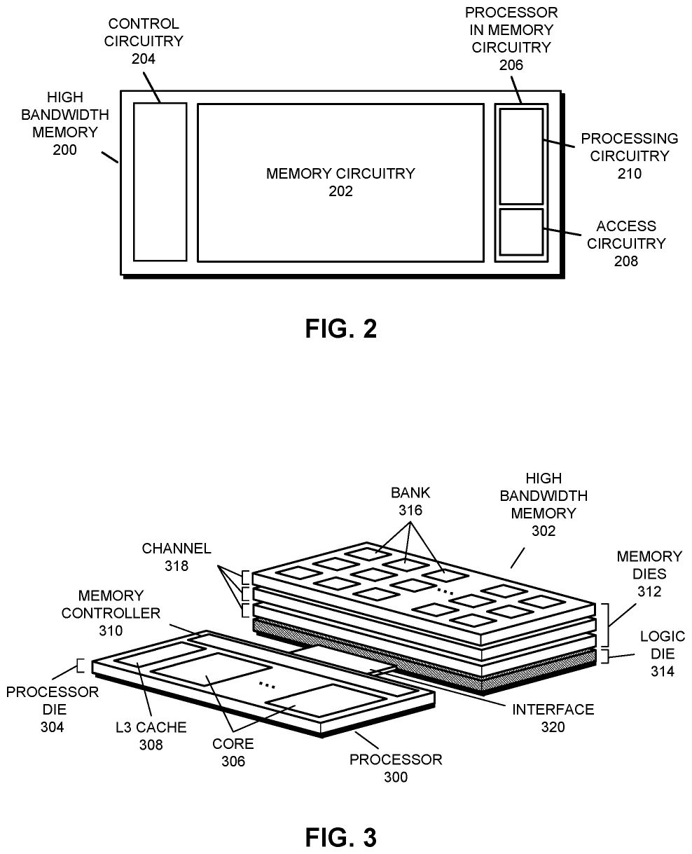

In the described implementations, an electronic device includes a high bandwidth memory (e.g., high bandwidth memory 108). FIG. 2 presents a block diagram illustrating a high bandwidth memory in accordance with some implementations. As can be seen in FIG. 2, high bandwidth memory 200 includes memory circuitry 202, control circuitry 204, and processor in memory circuitry 206. Memory circuitry 202 is a functional block that includes memory circuitry such as DDR5 SDRAM and/or other types of memory circuitry. In some implementations, the memory circuitry is arranged into a number of different arrays of memory circuitry, banks of memory circuitry, and channels of memory circuitry. For example, in some implementations, the memory circuitry includes N GiB of memory circuitry (where N=4, 6, or another number) physically or logically organized into respective arrays, banks, and channels. In some implementations, memory circuitry 202 includes a number of Mbyte rows of memory circuitry within the arrays, banks, and channels (where M=8 KiB, 12 KiB, or another number). In some of these implementations, some or all of the data stored in a given row of memory can be read out of the given row of memory to a buffer (e.g., a row buffer) in a read operation and can then be read from the buffer to be communicated to other entities (e.g., cores 112-114, processor in memory circuitry 206, etc.).

Control circuitry 204 is a functional block that includes circuitry for controlling some or all of the operations of high bandwidth memory 200. For example, control circuitry 204 can perform operations of interfacing and communicating with other functional blocks and devices (e.g., processor 102, processor in memory circuitry 206, etc.). As another example, control circuitry 204 can handle accesses of data in memory circuitry 202, such as by receiving and processing access requests from other functional blocks and devices. As yet another example, control circuitry 204 can synchronize operations of high bandwidth memory 200, maintain data in memory circuitry 202 (e.g., periodic refreshes, etc.), and/or perform other operations. As yet another example, control circuitry 204 can perform operations associated with identifying specified data (e.g., frequently accessed data, etc.) to be migrated between high bandwidth memory (i.e., memory circuitry 202) and another memory (e.g., memory 104).

Processor in memory circuitry 206 is a functional block that includes circuitry for performing operations on, using, and/or for data and/or metadata. Generally, processor in memory circuitry 206 can acquire data and/or metadata from memory circuitry 202 and/or from another source (e.g., data and/or metadata sent from the processor or another entity) and perform operations on the data and/or metadata—and/or can itself generate data and/or metadata. For example, in some implementations, for operations on data and/or metadata that is presently stored in memory circuitry 202, access circuitry 208 in processor in memory circuitry 206 reads the data and/or metadata from memory circuitry 202 (e.g., into a buffer in access circuitry 208, etc.), processing circuitry 210 next performs one or more operations on the data and/or metadata, and access circuitry 208 then writes the data and/or metadata back to the memory circuitry 202 and/or sends the data and/or metadata to another entity (e.g., processor 102, etc.). As another example, for data and/or metadata that is generated by processor in memory circuitry 206 and stored in memory circuitry 202 (e.g., newly generated data and/or metadata), processing circuitry 210 performs one or more operations to generate the data and/or metadata and access circuitry 208 then writes the newly generated data and/or metadata to the memory circuitry 202. As yet another example, for data and/or metadata that is received by processor in memory circuitry 206 from another entity and stored in memory circuitry 202 after having operations performed thereon, access circuitry 208 receives the data and/or metadata from the other entity (e.g., into a buffer in access circuitry 208, etc.), processing circuitry 210 performs one or more operations on the data and/or metadata, and access circuitry 208 then writes the data and/or metadata to the memory circuitry 202. In some implementations, by performing the operations on the data and/or metadata, processor in memory circuitry 206 avoids the need for other functional blocks (e.g., cores 112-114, etc.) to perform the operations—meaning that the data and/or metadata need not be communicated to, and possibly back from, the other functional blocks.

Depending on the implementation, processor in memory circuitry 206 can perform a number of different operations on, using, and/or for data and/or metadata. For example, in some implementations, processor in memory circuitry 206 includes simpler circuitry— and possibly dedicated circuitry—such as logic gates, arithmetic logic units, etc. that performs particular logical, bitwise, mathematical, comparison, and/or other operations on, using, and/or for data and/or metadata. For example, in some implementations, processor in memory circuitry 206 may add a given value to data and/or metadata, compare data and/or metadata to specified values to determine if the data and/or metadata is equal to the specified values, perform lookups of data, etc. As another example, in some implementations, processor in memory circuitry 206 includes more complex circuitry (e.g., microcontrollers, processor cores, gate arrays, etc.) that can perform multiple (and possibly a large number of different) logical, bitwise, mathematical, comparison, and/or other operations on, using, and/or for data and/or metadata. In some of implementations, processor in memory circuitry 206 executes program code instructions (e.g., firmware, applications, etc.) that configure processing circuitry to perform respective operations on, using, and/or for data and/or metadata.

In some implementations, processor in memory circuitry 206 itself initiates at least some operations, so that processor in memory circuitry 206 performs the operations on, using, and/or for data and/or metadata without receiving requests, commands, etc. from other entities (e.g., the processor, etc.). For example, processor in memory circuitry can initiate a given operation periodically, when one or more specified events have occurred, when data is accessed in memory circuitry 202, etc. In some implementations, another entity (e.g., the processor, etc.) communicates requests, commands, etc. to processor in memory circuitry 206 to cause processor in memory circuitry 206 to perform specified operations. In some of these implementations, the other entity can “offload” specified operations to processor in memory circuitry 206—and avoid the other entity performing the operations itself.

FIG. 3 presents an isometric view of a processor 300 and a high bandwidth memory 302 in accordance with some implementations. As can be seen in FIG. 3, processor 300 is fabricated on a processor die 304. Processor die 304 includes a number of cores 306, an L3 cache 308, and a memory controller 310. In other words, processor die 304 is a semiconductor integrated circuit chip with integrated circuits implementing cores 306, an L3 cache 308, and a memory controller 310 fabricated thereon. In some implementations, cores 306, L3 cache 308, and memory controller 310 are similar to cores 112-114, L3 cache 124, and memory controller 126.

High bandwidth memory 302 is fabricated on three memory dies 312 (i.e., semiconductor integrated circuit dies) and a logic/interface (LOGIC) die 314 that are arranged in a stack with logic die 314 bottommost in the stack. Each memory die 312 has memory circuitry fabricated thereon (e.g., DDR5 SDRAM memory circuitry, etc.). For example, in some implementations, each memory die 312 includes a number of banks 316 of memory circuitry, each bank 316 in turn including a number of arrays of memory circuitry (only three banks 316 are labeled in FIG. 3 for clarity). In some implementations, each memory die 312 is considered a separate channel 318 of the memory circuitry for accesses of data. Logic die 314 includes interface circuitry (e.g., transceivers, drivers, buffers, and/or other interface circuitry) and circuitry for handling interactions with processor 300, and some or all of control circuitry 204.

Communication routes (e.g., through silicon vias, etc.) (not shown) are connected between the memory dies 312 and logic die 314 to enable data stored in the memory circuitry on the memory dies 312 to be accessed by logic die 314. In some implementations, logic die 314 also includes memory circuitry—i.e., includes memory circuitry in die areas that are not taken up by other types of circuitry (i.e., interface circuitry, etc.).

In some implementations, some or all of the processor in memory circuitry (e.g., processor in memory circuitry 206) in high bandwidth memory 302 is located on logic die 314. In other words, in some implementations, some or all of the processor in memory circuitry (e.g., logic gates, ALUs, microcontrollers, processor cores, etc.) is fabricated on logic die 314. In some implementations, however, some or all of the processor in memory circuitry in high bandwidth memory 302 is distributed, with portions of the processor in memory circuitry on memory dies 312. For example, in some implementations, portions of the processor in memory circuitry are located in individual banks 316—so that there is per-bank processor in memory circuitry. For instance, in some implementations, the distributed processor in memory circuitry located on the memory dies 312 can be simpler processor in memory circuitry that can perform only a limited set of operations, while more complex processor in memory circuitry that can perform a larger set of operations is located on logic die 314.

Processor 300 is connected to high bandwidth memory 302 via interface 320. Interface 320 includes circuitry (e.g., transceivers, buffers, drivers, etc.), routing, guides, etc. for communication between processor 300 and high bandwidth memory 302. For example, in some implementations, processor 300 and high bandwidth memory are mounted to an interposer that includes circuitry, routes, guides, etc. for interface 320—and the combination of interposer, processor 300, and high bandwidth memory 302 are enclosed in a package (e.g., a pin grid array package). In some implementations, interface 320 is “high-speed” and is therefore able to transfer/communicate data, requests, etc. at a higher (and possibly a significantly higher) rate than other interfaces used by processor 300 for otherwise transferring/communicating data (e.g., fabric 110, etc.). For example, interface 320 may be a wider parallel interface having a larger number of parallel communication lines/routes, a faster serial interface, etc. In some implementations, high bandwidth memory is considered “high bandwidth” due to the ability to transfer/communicate data to and from processor 300 at higher rates via interface 320 and the interface circuitry in logic die 314.

Although particular arrangements of elements are illustrated in FIGS. 2-3, in some implementations, different elements may be present. For example, in some implementations, another number or arrangement of stacked memory dies 312 are used, the circuitry described as being included one logic die 314 is located on or distributed among memory dies 312 (and thus logic die 314 may not be present), etc. As another example, in some implementations, the memory circuitry on the memory dies 312 is arranged differently. Generally, the described implementations can use any number or arrangement of functional blocks and devices that perform the operations herein described.

### High Bandwidth Memory as a Cache Memory

In some implementations, some or all of the memory circuitry in a high bandwidth memory (e.g., memory circuitry 202, etc.) is used for storing cache blocks for a cache memory. In other words, at least some of the memory circuitry in the high bandwidth memory functions as a cache memory that is used for storing copies of data for use by other entities (e.g., processor 102, etc.). For example, in some implementations, the high bandwidth memory functions as a lowest cache in a hierarchy of caches, such as a level four (L4) cache in an implementation in which a processor includes L1-L3 caches (e.g., L1 caches 116-118, L2 caches 120-122, and L3 cache 124). In these implementations, cache blocks with copies of data from a memory, a mass storage (e.g., memory 104 and/or mass storage 106), higher level cache memories, a processor, and/or other entities are stored in locations in the memory circuitry of the high bandwidth memory cache memory.

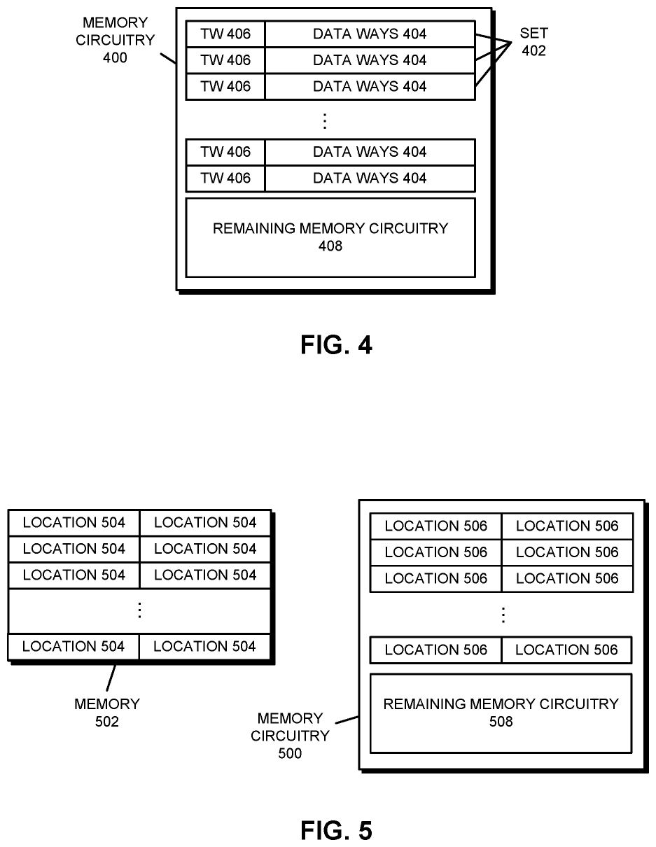

FIG. 4 presents a block diagram illustrating memory circuitry 400 in a high bandwidth memory used as a cache in accordance with some implementations. For the example in FIG. 4, it is assumed that the cache is set associative, and thus cache blocks with data from specified address ranges are stored in ways in respective sets of cache locations. As can be seen in FIG. 4, the memory circuitry that is used as a cache memory is divided into a number of cache sets 402 (only three of which are labeled in FIG. 4 for clarity). Each set includes a number of ways. Each of the ways in a given set 402 is used either as a data way 404 or a tag way 406, with data ways 404 configured for storing cache blocks and tag ways 406 configured for storing metadata for the cache blocks stored in respective data ways 404. For example, in some implementations, each cache set 402 is stored in 2 kiB of memory circuitry divided into thirty two 64-byte ways with twenty nine of the ways used as data ways for storing cache blocks and three of the ways in each set used as tag ways for storing cache block identification tags and/or other metadata. Remaining memory circuitry 408 includes the remaining memory circuitry of memory circuitry 400, which may be used for other purposes, including as a portion of a memory (e.g., an operating system visible memory) such as described for FIG. 5.

Although a particular number and arrangement of elements is shown in FIG. 4, in some implementations, a different number and/or arrangement of elements is present. For example, in some implementations, all of the memory circuitry 400 is used as a cache—and there is no remaining memory circuitry 408. As another example, in some implementations, a different form of associativity is used, such as direct associativity, skewed associativity, etc. Generally, in some implementations, some or all of the memory circuitry in high bandwidth memory is used as a cache for performing the operations described herein.

### High Bandwidth Memory as a Portion of Memory

In some implementations, some or all of the memory circuitry in a high bandwidth memory (e.g., memory circuitry 202) is used as part of a memory in an electronic device (e.g., memory 104). In other words, in some implementations, at least some of the memory circuitry in the high bandwidth memory functions as an operating system (OS) visible memory for storing copies of data for use by other entities (e.g., processor 102, etc.). In these implementations, the addressable locations of the memory include locations in both the memory itself and the high bandwidth memory, so that the high bandwidth memory serves as/includes an additional set of locations for the memory. For example, assuming a 32 GiB memory (e.g., that memory 104 includes 32 GiB of addressable memory circuitry) and that 4 GiB of memory circuitry in the high bandwidth memory is used as part of the memory, the overall addressable space for the memory is 36 GiB. In these implementations, copies of data from a mass storage (e.g., mass storage 106), a processor, and/or other entities can be stored in locations in the memory circuitry or the high bandwidth memory.

In some implementations, the operating system manages the memory, in that the operating system itself controls locations in which data are stored in the memory or the high bandwidth memory. In some implementations, control circuitry in the memory, the high bandwidth memory, and/or in another location (e.g., on the processor) manages the memory so that the memory is managed “in hardware.” In the latter implementations, the operating system and/or other software entities may not have ultimate control of where data is stored in the memory or the high bandwidth memory and instead the control circuitry determines where the data is stored. In some of the latter implementations, the control circuitry opportunistically “migrates,” or move, specified data (e.g., more-frequently or high-priority data) from the memory to the high bandwidth memory and/or migrate specified data (e.g., migrate less-frequently or lower-priority data) from the high bandwidth memory to the memory. For migrating data, the control circuitry monitors data accesses in the memory and/or the high bandwidth memory to identify the specified data and can then migrate the specified data between the memory and the high bandwidth memory. For migrating data, the control circuitry keeps a remapping record in the high bandwidth memory that maps physical addresses to where data is migrated to physical addresses from where data was migrated. The remapping record is then used for finding migrated data during memory accesses, i.e., for locating physical addresses where the migrated data is presently stored. Note that, in both of the above-described cases, i.e., when the memory is OS managed and when the memory is managed by the control circuitry, the memory is “visible” to the OS in that the OS is able to perform memory accesses for accessing data in the memory.

FIG. 5 presents a block diagram illustrating memory circuitry 500 in a high bandwidth memory used as operating system visible memory in accordance with some implementations. While memory circuitry 500 is memory circuitry in a high bandwidth memory (e.g., memory circuitry 202), memory 502 is memory circuitry in a memory (e.g., memory 104). As can be seen in FIG. 5, memory 502 includes a number of locations 504. Locations 504 are portions of memory that can be individually accessed using respective memory addresses. For example, in some implementations, memory 502 includes K GiBs of memory circuitry that can be accessed, and is thus addressed, at the byte level and/or another level (where K=16, 48, or another number)—and thus each location 504 includes one or more bytes. In addition, memory circuitry 500 includes a number of locations 506. Locations 506 are portions of memory circuitry 500 that can be individually accessed using respective memory addresses. For example, in some implementations, memory circuitry 500 includes P GiBs of memory circuitry that can be accessed, and is thus addressed, at the byte level and/or another level (where P=2, 4, or another number). Remaining memory circuitry 508 includes the remaining memory circuitry of memory circuitry 500, which may be used for other purposes, including as cache such as described for FIG. 4.

Although a particular number and arrangement of elements is shown in FIG. 5, in some implementations, a different number and/or arrangement of elements is present. For example, in some implementations, all of the memory circuitry 500 is used as operating system visible memory—and there is no remaining memory circuitry 508. Generally, in some implementations, some or all of the memory circuitry in high bandwidth memory is used as an operating system visible memory—and can perform the operations described herein.

### Processor in Memory Operations for a High Bandwidth Memory Cache Memory

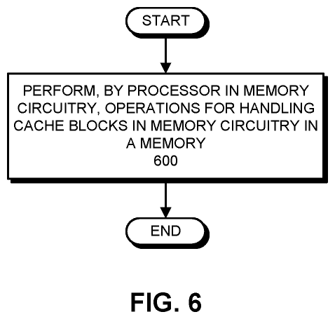

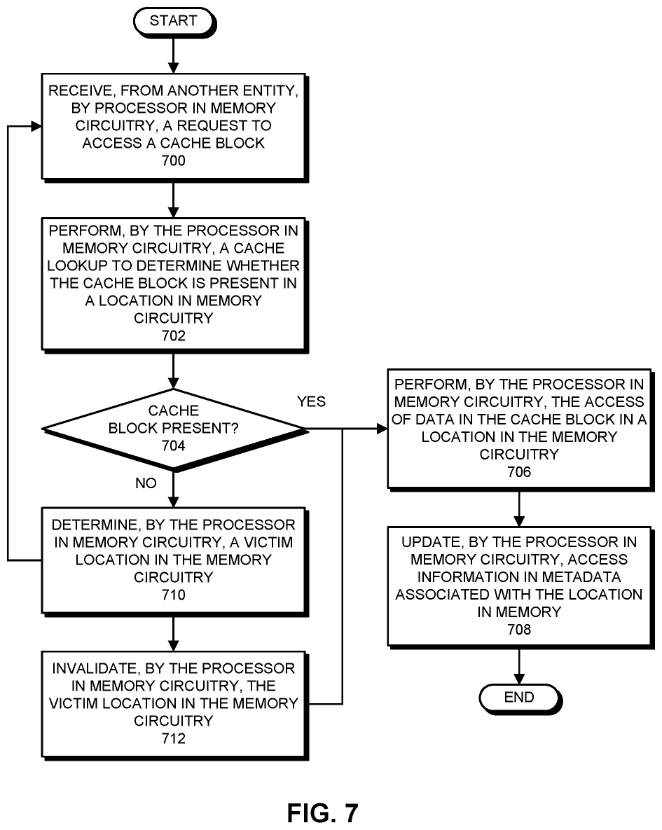

In some implementations, some or all of the memory circuitry in a high bandwidth memory (e.g., memory circuitry 202) is used as a cache memory—i.e., a high bandwidth memory cache. For example, the memory circuitry may be used as a cache as described above for FIG. 4. In some of these implementations, processor in memory (PIM) circuitry in the high bandwidth memory (e.g., processor in memory circuitry 206) performs operations for handling cache blocks in the high bandwidth memory cache. FIG. 6 presents a flowchart illustrating a process for handling cache blocks in memory circuitry in a memory by processor in memory circuitry in accordance with some implementations. FIG. 6 is presented as a general example of operations performed in some implementations. In other implementations, however, different operations are performed and/or operations are performed in a different order. Additionally, although certain elements are used in describing the process, in some implementations, other elements perform the operations. The operations in FIG. 6 include the processor in memory circuitry performing operations for handling cache blocks in memory circuitry in a memory—i.e., in memory circuitry in a high bandwidth memory (step 600). Generally, for this operation, the processor in memory circuitry performs operations associated with using the memory circuitry in the high bandwidth memory cache—thereby avoiding the need for the processor (and/or other entities) to perform some or all of the operations for handling the cache blocks. These operations can include any operation for handling data in cache blocks and/or associated metadata, such as operations associated with accessing data in cache blocks and/or associated metadata, invalidating or managing data in cache blocks, improving performance of the cache memory, etc. Some examples of the operations that may be performed by the processor in memory circuitry are described below and shown in FIGS. 7-9.

### Accessing Data in Cache Blocks

In some implementations, the operations performed by processor in memory circuitry for handling cache blocks in a high bandwidth memory cache include operations associated with accesses of data in cache blocks in the cache memory. For example, the operations can be associated with accesses such as reads of data in the cache blocks, writes of data in the cache blocks, invalidations of cache blocks, etc. FIG. 7 presents a flowchart illustrating a process for handling accesses of cache blocks in a memory by processor in memory circuitry in accordance with some implementations. FIG. 7 is presented as a general example of operations performed in some implementations. In other implementations, however, different operations are performed and/or operations are performed in a different order. Additionally, although certain elements are used in describing the process, in some implementations, other elements perform the operations.

For the example in FIG. 7, the access of data in a cache block in a high bandwidth memory cache is assumed to be a write/store of data in a cache block in the cache memory. In other words, an entity (e.g., processor 102, etc.) is assumed to have requested that specified data be written/stored in a cache block in the cache memory. Although a write is described for FIG. 7, in some implementations, at least some similar operations can be performed for other accesses of data in cache blocks in the cache memory. In addition, for the example in FIG. 7, it is assumed that the high bandwidth memory cache is organized as set associative and therefore includes a number of sets and ways. Each set includes multiple ways (e.g., 4, 12, or another number) into which cache blocks from respective ranges of memory addresses can be stored. It is also assumed that the high bandwidth memory cache is managed in accordance with a least recently used (LRU) cache management policy in which least recently used cache blocks within sets are evicted to free space for incoming cache blocks for the sets. Although an LRU cache management policy is assumed to be used for managing the cache (i.e., for selecting cache blocks for eviction, etc.), in some implementations, other or additional cache management policies can be used for managing the cache (e.g. least frequently used and/or other cache management policy).

The operations in FIG. 7 start when the processor in memory circuitry receives, from another entity (e.g. processor 102, etc.) a request to access a cache block (step 700). As part of this operation, the processor in memory circuitry receives an identification of the cache block to be written in the high bandwidth memory cache. For example, the processor in memory circuitry can receive a tag including some or all of the bits of an address associated with the data or a value computed based thereon. The processor in memory circuitry then performs a cache lookup to determine whether the cache block is present in a location in the memory circuitry in the high bandwidth memory cache (step 702). For this operation, processor in memory circuitry compares received identification information for the cache block to identification information for cache blocks that are presently in the high bandwidth memory cache to determine if the cache block is presently in the high bandwidth memory cache. For example, the processor in memory circuitry can compare the received tag to each valid tag associated with cache blocks presently in ways in a set into which the cache block is to be written.

When the cache block is present (step 704), and thus there is a “hit” for the cache block in the high bandwidth memory cache, the processor in memory circuitry performs the access of the data in the cache block in a location in the memory circuitry (step 706). For this operation, when the cache block is found to be present in the high bandwidth memory cache, the processor in memory circuitry writes the received data to the cache block. In other words, when the cache block is present in a way within a given set in the high bandwidth memory cache, the processor in memory circuitry performs a write operation to update the cache block with the received data. After performing the access, the processor in memory circuitry updates access information in metadata associated with the location in the memory (step 708). For this operation, the processor in memory circuitry updates access information such as the least recently used (LRU) bit(s) for the location in the memory—and possibly other locations in the memory. For example, when the LRU bit(s) are set for the location in the memory and at least one other cache block is present in the set and was accessed less recently, the processor in memory circuitry can clear the LRU bit for the location in the memory and set the LRU bit for the other cache block.

When, however, the cache block is not present (step 704), and thus there is a “miss” for the cache block in the high bandwidth memory cache, the processor in memory loads the cache block to the high bandwidth memory cache. For this operation, the processor in memory circuitry first determines a victim location in the memory circuitry (step 710). For determining the victim location, the processor in memory circuitry finds a location in the high bandwidth memory cache where data for the cache block is to be written. Continuing the example, the processor in memory circuitry determines a way in a set into which the cache block is to be written. For example, the processor in memory circuitry can search metadata associated with the locations in the high bandwidth memory cache, i.e., metadata associated with ways in the set, to find a least recently used cache block via the values of the LRU bits. It is assumed for the example that there is no empty way in the set and thus the determined location is a “victim” location—in that the existing cache block in the location will need to be invalidated. The processor in memory circuitry therefore invalidates the victim location in the memory circuitry (step 712). For this operation, the processor in memory circuitry can simply invalidate a “clean” cache block that does not store modified data (i.e., that matches the data stored in memory and/or mass storage). For a “dirty” cache block that stores modified data, however, the processor in memory circuitry evicts the cache block, such as by writing the copy of the data in the cache block to a corresponding location in memory. The processor in memory circuitry then proceeds to step 706 to perform the access in the victim location (note that the “victim location” is described as “location” in steps 706-708 to align with the earlier/other description in FIG. 7).

In the described implementations, the various operations described for FIG. 7 are performed in the processor in memory circuitry itself, instead of in another entity (e.g., processor 102). This means that the other entity need not be involved with these operations after communicating the request to access the cache block, which reduces the operational load on the other entity, the delay associated with accessing the cache block, etc. In addition, in some implementations, this means that the other entity may not keep or otherwise maintain information associated with cache blocks in the high bandwidth memory cache, such as identifier information, metadata, etc. Because the information need not be kept by the other entity, the other entity need not include circuitry (e.g., memory elements, registers, etc.) used for storing the information, which can help to simplify the circuitry in the other entity.

In some implementations, for the operations described in FIG. 7, the processor in memory circuitry includes dedicated and/or purpose-specific circuitry for performing some or all of the operations (e.g., the receiving, looking up/comparing, accessing, invalidating, etc.). In some implementations, however, the processor in memory circuitry includes general purpose circuitry (e.g., instruction execution circuitry, etc.) that is used for performing some or all of the operations described for FIG. 7.

### Hot Swapping Cache Blocks

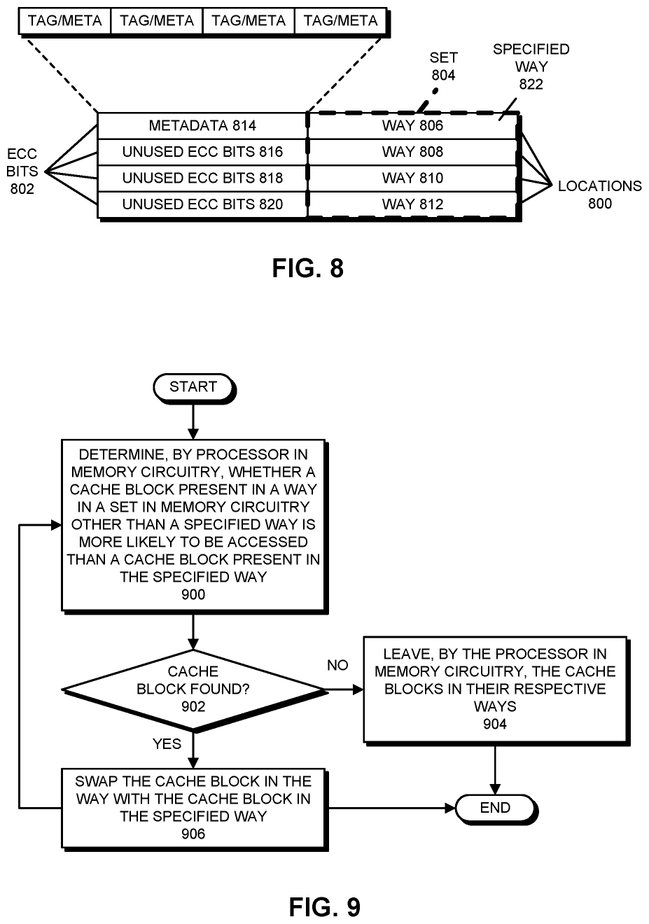

In some implementations, error correction code (ECC) bits are included in memory circuitry (e.g., memory circuitry 202) during fabrication/manufacture and are intended to be used for storing ECC information that is used for detecting and/or correcting certain bit errors in data stored in the associated locations. Because the ECC bits are not used for storing error correction code information in some implementations (this function is performed elsewhere), the ECC bits are repurposed for storing metadata for cache blocks present in locations in the memory circuitry. FIG. 8 presents a block diagram illustrating locations 800 in memory circuitry and corresponding ECC bits 802 in accordance with some implementations. As can be seen in FIG. 8, locations 800 are used for storing a set 804 that includes four ways, ways 806-812. Metadata 814 for the four ways 806-812 is stored in a first set of ECC bits 802, while the remaining ECC bits are unused (shown as unused ECC bits 816-820). An expanded view of metadata 814 is shown at the top of FIG. 8. As can be seen in the expanded view, metadata 814 includes a tag and metadata (TAG/META) for each of the four ways 806-812. For example, the first tag and metadata in metadata 814 is associated with way 806, the second tag and metadata are associated with way 808, etc. Each tag includes an identifier (e.g., a portion of an address) for a cache block stored in the respective way and each metadata includes metadata for that cache block (e.g., a valid bit, a dirty/modified bit, etc.)

In some implementations, due to the arrangement of memory circuitry and read circuitry (e.g., in a given row of memory), when reading ECC bits 802, the data in the corresponding location 800 is also/automatically read. For example, when reading metadata 814 in the corresponding ECC bits 802, the data for the cache block (if any) in way 806 is also read. Because this is true, when accessing tag information for performing a lookup to determine whether a given cache block is present in one of ways 806-812, processor in memory circuitry (e.g., processor in memory circuitry 206) reads the data in metadata 814 and way 806 in a single read. The cache block in way 806 is therefore automatically read each time that the ways 806-812 in set 804 are searched to determine if a cache block is present in the high bandwidth memory cache. Way 806 is therefore considered the “specified” way 822 because way 806 is the only way that is automatically read when the metadata is read—ways 808-812 must be read in a separate read following the lookup to access a cache block present therein. Because the specified way 822 is automatically read during the read of metadata 814, if a cache block being searched for is present in the specified way 822, that cache block is already read (and therefore does not require an additional read) during the lookup operation—and can be immediately returned to a requesting entity (e.g., processor 102).

In some implementations, the operations performed by processor in memory circuitry (e.g., processor in memory circuitry 206) for handling cache blocks in a high bandwidth memory cache include operations associated with hot swapping cache blocks. Generally, “hot swapping” cache blocks involves moving cache blocks that are more likely to be accessed, or “hot” cache blocks, into a specified way in a set (e.g., specified way 822) so that the hot cache blocks are read automatically during a cache block lookup operation as described above. This can mean moving other cache blocks out of the specified way to make room for the hot cache blocks—by “swapping” a hot cache block and another cache block in their respective ways. FIG. 9 presents a flowchart illustrating a process for swapping cache blocks in a memory by processor in memory circuitry in accordance with some implementations. FIG. 9 is presented as a general example of operations performed in some implementations. In other implementations, however, different operations are performed and/or operations are performed in a different order. Additionally, although certain elements are used in describing the process, in some implementations, other elements perform the operations.

For the example in FIG. 9, it is assumed that the high bandwidth memory cache is organized as set associative and therefore includes a number of sets and ways. Each set includes multiple ways into which cache blocks from respective ranges of memory addresses can be stored. For example, in some implementations, the high bandwidth memory cache is organized similarly to what is shown in FIG. 8, with four ways (e.g., ways 806-812) per set (e.g., set 804). It is also assumed that the high bandwidth memory cache is managed in accordance with a least recently used (LRU) cache management policy under which least recently used cache blocks within sets are evicted to free space for incoming cache blocks for the sets. Although an LRU cache management policy is assumed to be used for managing the cache (i.e., for selecting cache blocks for eviction, etc.), in some implementations, other or additional cache management policies can be used for managing the cache (e.g. least frequently used and/or other cache management policy).

The operations in FIG. 9 start when the processor in memory circuitry determines whether a cache block present in a way in a set in memory circuitry other than a specified way is more likely to be accessed than a cache block present in the specified way (step 900). Continuing the example from FIG. 8, this operation includes determining if a cache block (if any) stored in one of ways 808-812 is more likely to be accessed than a cache block in way 806, which is the specified way 822. For this operation, the processor in memory circuitry uses access information such as an MRU bit and/or other information (e.g., tracking information maintained by processor in memory circuitry, etc.) to determine whether the cache block (if any) present in each way other than the specified way is more likely to be accessed. For example, the processor can determine if an MRU bit is set for a cache block in one of the ways other than the specified way—and thus the cache block was more recently used than the cache block in the specified way. When a cache block is more recently used in these implementations, the cache block is assumed to be more likely to be reused than cache blocks in other ways in the set. For this operation, therefore, the processor in memory circuitry determines whether a “hot” cache block is present in a way other than the specified way.

When the hot cache block is already present in the specified way (step 902), the processor in memory circuitry leaves the cache blocks in their respective ways (step 904). For this operation, because the hot cache block is already present in the specified way, the processor in memory circuitry makes no changes to the cache blocks present in each of the ways, thereby leaving the hot cache block in the automatically read way (as described above). In contrast, when a hot cache block is found in a way other than the specified way (step 902), the processor in memory circuitry swaps the cache block in the way other than the specified way with the cache block in the specified way (step 906). For this operation, the processor in memory circuitry moves the hot cache block from its present way into the specified way and moves the other cache block from the specified way into the present way. For example, and continuing the example from FIG. 8, assuming that the hot cache block is found in way 810, the processor in memory circuitry moves the cache block presently in way 806, which is the specified way 822, to way 810 and moves the hot cache block from way 810 to way 806 (this operation can include temporarily buffering one of the cache blocks while the swap happens).

In the described implementations, the various operations described for FIGS. 8-9 are performed in the processor in memory circuitry itself, instead of by another entity (e.g., processor 102). The means that the other entity need not be involved with these operations, which reduces the operational load on the other entity, the delay associated with accessing the cache block, etc. In some implementations, performing the hot swapping operation in the processor in memory circuitry can enable hot swapping to be performed at all—or can enable more hot swapping than might otherwise be possible—as the processing is performed locally in the high bandwidth memory cache.

In some implementations, the processor in memory circuitry performs the operations shown in FIGS. 8-9 for each of multiple cache blocks. In other words, although a single cache block is described for FIGS. 8-9, the processor in memory circuitry can perform the operations for any number of cache blocks. For example, in some implementations, the processor in memory circuitry proceeds through the high bandwidth memory cache, performing the operations shown in FIGS. 8-9 for each set and/or for specified sets—and may start over with an initial set when all the sets have been processed.

In some implementations, the processor in memory circuitry performs the operations shown in FIGS. 8-9 at specified times, so that the hot swapping does not interfere with other cache operations (e.g., cache block accesses, etc.). For example, the processor in memory circuitry can perform the operations shown in FIGS. 8-9 during idle times, in a specified swapping window/period of time, etc.

In some implementations, for the operations described in FIGS. 8-9, the processor in memory circuitry includes dedicated and/or purpose-specific circuitry for performing some or all of the operations. In some implementations, however, the processor in memory circuitry includes general purpose circuitry (e.g., instruction execution circuitry, etc.) that is used for performing some or all of the operations described for FIGS. 8-9.

### Handling Dead Cache Blocks

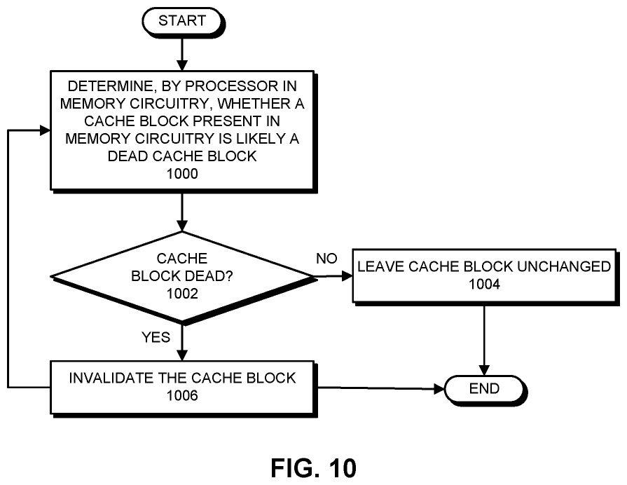

In some implementations, the operations performed by processor in memory circuitry (e.g., processor in memory circuitry 206) for handling cache blocks in a high bandwidth memory cache include operations associated with identifying and invalidating dead cache blocks. Generally, identifying dead cache blocks involves predicting that a cache block is unlikely to be accessed and is therefore “dead.” For example, a cache block may be included in a sequence of single-access cache blocks for a data processing operation (e.g., streaming audio, etc.) and may therefore be considered a dead cache block (after the single access). Dead cache blocks take up space in high bandwidth memory cache that might otherwise be used for storing useful cache blocks and are therefore inefficient to retain in the high bandwidth memory cache. The processor in memory circuitry therefore invalidates the cache blocks, which frees the memory circuitry in which the dead cache block was stored for storing other cache blocks. FIG. 10 presents a flowchart illustrating a process for handling dead cache blocks in a memory by processor in memory circuitry in accordance with some implementations. FIG. 10 is presented as a general example of operations performed in some implementations. In other implementations, however, different operations are performed and/or operations are performed in a different order. Additionally, although certain elements are used in describing the process, in some implementations, other elements perform the operations

The operations in FIG. 10 start when the processor in memory circuitry determines whether a cache block present in memory circuitry (e.g., memory circuitry 202) is likely a dead cache block (step 1000). For this operation, the processor in memory circuitry uses metadata for the cache block, cache access patterns, and/or other information to determine whether the cache block present in the memory circuitry is unlikely to be accessed (or will only be accessed once)—and is therefore considered dead. For example, in some implementations, as a cache block is stored in the high bandwidth memory cache, the processor in memory circuitry analyzes information associated with the cache block to determine whether the cache block is unlikely to be again accessed. For instance, the processor in memory circuitry can use information such as an access pattern of prior cache blocks, a record of historical accesses of that particular cache block, etc. for the determination. In some implementations, the processor in memory circuitry itself maintains the information associated with the cache block. In some implementations, however, the processor in memory circuitry receives or retrieves the information from another source.

In some implementations, the determination in step 1000 is a “prediction,” in that the processor in memory circuitry does not know with certainty whether or not the dead cache block will be again accessed. For example, using an access pattern to determine whether a cache block is dead works until the access pattern changes. Although this is true, no functional error will occur if the prediction is incorrect, as the cache block can simply be reloaded. While reloading mispredicted dead cache blocks has a cost in terms of latency, operational effort, etc., the benefit of invalidating dead cache blocks and thus freeing up space in the high bandwidth memory cache can outweigh the cost.

When the cache block is not dead (step 1002), the processor in memory circuitry leaves the cache block unchanged (step 1004). In other words, when a cache block is determined to be likely to be accessed again—or is not or cannot be determined to be dead—the processor in memory circuitry does nothing to the cache block, thereby leaving the cache block as-is in the memory circuitry. In contrast, when the cache block is determined to be dead (step 1002), the processor in memory circuitry invalidates the cache block (step 1006). For this operation, for a clean cache block, i.e., a cache block that matches the copy of the cache block stored in a memory (e.g., memory 104) and thus does not need to be written back to memory, the processor in memory circuitry simply invalidates the cache block. For example, the processor in memory circuitry can set metadata associated with a location in memory where the cache block is stored to indicate that there is no valid cache block stored in that location. On the other hand, for a dirty/modified cache block, i.e., a cache block that does not match the copy of the cache block stored in a memory (e.g., memory 104) and thus needs to be written back to memory, the processor in memory circuitry writes the data of the cache block back to memory and then invalidates the cache block.

In the described implementations, the various operations described for FIG. 10 are performed in the processor in memory circuitry itself, instead of by another entity (e.g., processor 102). The means that the other entity need not be involved with these operations, which reduces the operational load on the other entity, the delay associated with accessing the cache block, etc. In some implementations, performing the dead cache block operations in the processor in memory circuitry can enable these operations to be performed at all—or can enable more dead cache block operations than might otherwise be possible—as the processing is performed locally in the high bandwidth memory cache.

In some implementations, the processor in memory circuitry performs the operations shown in FIG. 10 for each of multiple cache blocks. In other words, although a single cache block is described for FIG. 10, the processor in memory circuitry can perform the operations for any number of cache blocks. For example, in some implementations, the processor in memory circuitry proceeds through the high bandwidth memory cache, performing the operations shown in FIG. 10 for each cache block and/or for specified cache blocks—and may start over with an initial cache block when all the cache blocks have been processed.

In some implementations, the processor in memory circuitry performs the operations shown in FIG. 10 at specified times in order to avoid interfering with other cache operations (e.g., cache block accesses, etc.). For example, the processor in memory circuitry can perform the operations shown in FIG. 10 during idle times, in a specified window/period of time, etc. In some implementations, the processor in memory circuitry performs the operations shown in FIG. 10 for only a subset of the cache blocks in the high bandwidth memory cache at a time—e.g., as many as possible during an idle period, etc.

In some implementations, for the operations described in FIG. 10, the processor in memory circuitry includes dedicated and/or purpose-specific circuitry for performing some or all of the operations. In some implementations, however, the processor in memory circuitry includes general purpose circuitry (e.g., instruction execution circuitry, etc.) that is used for performing some or all of the operations described for FIG. 10.

### Compressing Data in Cache Blocks

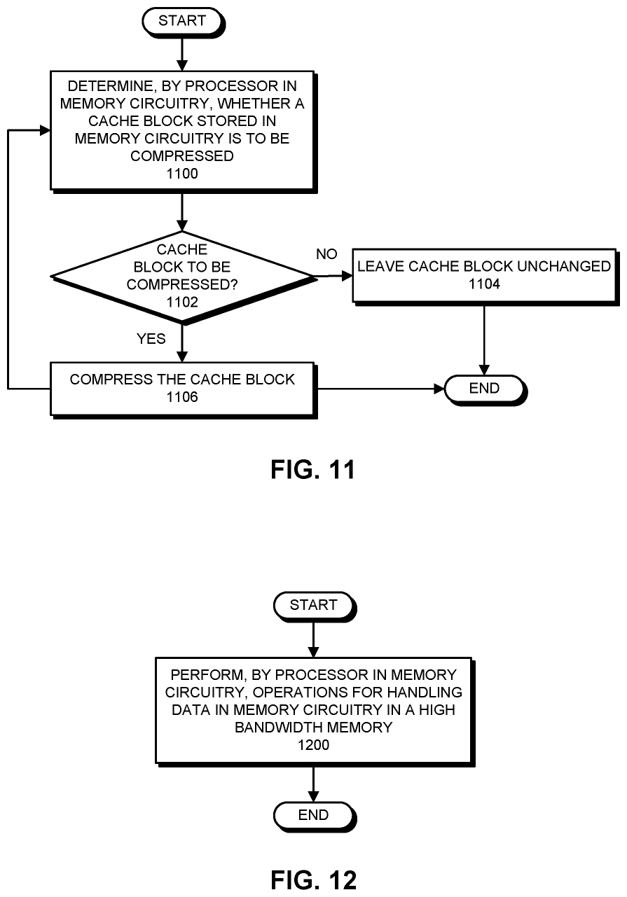

In some implementations, the operations performed by processor in memory circuitry (e.g., processor in memory circuitry 206) for handling cache blocks in a high bandwidth memory cache include operations associated with compressing data in cache blocks. Generally, data in cache blocks can be compressed using various techniques that result in reduced data size for the cache blocks—and may enable multiple cache blocks to be stored together in a given location that would otherwise only store one cache block, etc. The processor in memory circuitry therefore analyzes cache blocks to determine cache blocks that can be compressed and compresses those cache blocks. FIG. 11 presents a flowchart illustrating a process for compressing data in cache blocks in a memory by processor in memory circuitry in accordance with some implementations. FIG. 11 is presented as a general example of operations performed in some implementations. In other implementations, however, different operations are performed and/or operations are performed in a different order. Additionally, although certain elements are used in describing the process, in some implementations, other elements perform the operations

The operations in FIG. 11 start when the processor in memory circuitry determines whether a cache block present in memory circuitry (e.g., memory circuitry 202) is to be compressed (step 1100). For this operation, the processor in memory circuitry analyzes the data in the cache block and/or other information about the cache block to determine whether a given compression can be applied to the data in the cache block. For example, in some implementations, the processor in memory circuitry determines whether the data in the cache block has a specified compressible value. For instance, the processor in memory circuitry can determine whether bits of the data match a pattern (e.g., is all zeros, all ones, alternating zeros and ones, zeros and/or ones in particular locations, etc.).

When the cache block is not to be compressed (step 1102), the processor in memory circuitry leaves the cache block unchanged (step 1104). In other words, when the processor in memory circuitry determines that the cache block is not a candidate for compression (e.g., does not include a specified value, etc.) the processor in memory circuitry does nothing to the cache block, thereby leaving the cache block as-is in the memory circuitry. In contrast, when the cache block is to be compressed (step 1102), the processor in memory circuitry compresses the cache block (step 1106). For this operation, the operations performed by the processor in memory circuitry for compressing the cache block depend on the compression in use. For example, the processor in memory circuitry may replace data in the cache block with smaller data such as a reference to a location where a fixed pattern is stored in the high bandwidth memory cache (or elsewhere), may reduce data by combining data internally or removing redundant data, etc.

In the described implementations, the various operations described for FIG. 11 are performed in the processor in memory circuitry itself, instead of by another entity (e.g., processor 102). The means that the other entity need not be involved with these operations, which reduces the operational load on the other entity, the delay associated with accessing the cache block, etc. In some implementations, performing the compression operations in the processor in memory circuitry can enable these operations to be performed at all—or can enable more compression operations than might otherwise be possible—as the processing is performed locally in the high bandwidth memory cache.

In some implementations, the processor in memory circuitry performs the operations shown in FIG. 11 for each of multiple cache blocks. In other words, although a single cache block is described for FIG. 11, the processor in memory circuitry can perform the operations for any number of cache blocks. For example, in some implementations, the processor in memory circuitry proceeds through the high bandwidth memory cache, performing the operations shown in FIG. 11 for each cache block and/or for specified cache blocks—and may start over with an initial cache block when all the cache blocks have been processed.

In some implementations, the processor in memory circuitry performs the operations shown in FIG. 11 at specified times in order to avoid interfering with other cache operations (e.g., cache block accesses, etc.). For example, the processor in memory circuitry can perform the operations shown in FIG. 11 during idle times, in a specified window/period of time, etc. In some implementations, the processor in memory circuitry performs the operations shown in FIG. 11 for only a subset of the cache blocks in the high bandwidth memory cache at a time— e.g., as many as possible during an idle period, etc. In some implementations, for the operations described in FIG. 11, the processor in memory circuitry includes dedicated and/or purpose-specific circuitry for performing some or all of the operations. In some implementations, however, the processor in memory circuitry includes general purpose circuitry (e.g., instruction execution circuitry, etc.) that is used for performing some or all of the operations described for FIG. 11.

### Combinations of Operations on Cache Blocks

In some implementations, processor in memory circuitry can perform combinations of two or more operations on cache blocks. For example, in some implementations, the processor in memory circuitry can perform some or all of the operations shown in FIGS. 10-11 as a combination. In some of these implementations, the processor in memory circuitry performs the operations of FIG. 10, i.e., dead cache block invalidation, prior to performing the operations of FIG. 11. In other words, the processor in memory circuitry first attempts to invalidate given cache block(s) and then attempts to compress given cache block(s) that were not invalidated. Generally, in the described implementations, the processor in memory circuitry can perform various combinations of operations on a cache block (or cache blocks).

### Processor in Memory Operations for a High Bandwidth Memory Cache Memory

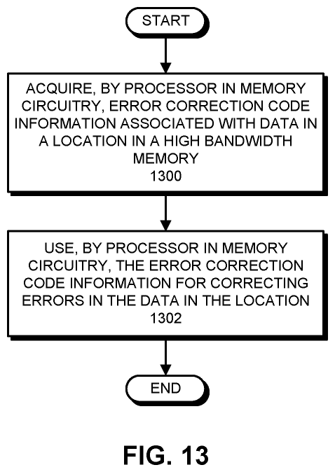

In some implementations, some or all of the memory circuitry in a high bandwidth memory (e.g., memory circuitry 202) is used as operating system visible memory. For example, the memory circuitry may be used as memory as described above for FIG. 5. In some of these implementations, processor in memory circuitry in the high bandwidth memory (e.g., processor in memory circuitry 206) performs operations for handling data in the portion of the operating system visible memory in the high bandwidth memory. FIG. 12 presents a flowchart illustrating a process for handling data in memory circuitry in a memory by processor in memory circuitry in accordance with some implementations. FIG. 12 is presented as a general example of operations performed in some implementations. In other implementations, however, different operations are performed and/or operations are performed in a different order. Additionally, although certain elements are used in describing the process, in some implementations, other elements perform the operations. The operations in FIG. 12 include the processor in memory circuitry performing operations for handling data in memory circuitry in a high bandwidth memory (step 1200). Generally, for this operation, the processor in memory circuitry performs operations associated with using the memory circuitry in the high bandwidth memory as an extension of another memory (e.g., memory 104) that is visible to the operating system—thereby avoiding the need for the processor (and/or other entities) to perform some or all of the operations for handling the data. These operations can include any operation for handling data and/or associated metadata in the memory, such as operations associated with accessing data and/or associated metadata, determining locations in the memory where migrated data is stored, invalidating or managing data and/or associated metadata, improving performance of the memory, maintaining data and/or associated metadata in the memory, etc. An example of the operations that may be performed by the processor in memory circuitry is described below and shown in FIG. 13.

In some implementations, operations performed by processor in memory circuitry for handling data in a portion of the memory circuitry in a high bandwidth memory used as operating system visible memory include a memory scrubbing operation. FIG. 13 presents a flowchart illustrating a process for handling memory scrubbing of data in a high bandwidth memory by processor in memory circuitry in accordance with some implementations. FIG. 13 is presented as a general example of operations performed in some implementations. In other implementations, however, different operations are performed and/or operations are performed in a different order. Additionally, although certain elements are used in describing the process, in some implementations, other elements perform the operations.

The operations shown in FIG. 13 start when the processor in memory circuitry acquires error correction code (ECC) information associated with data in a location in a high bandwidth memory (step 1300). For this operation, the processor in memory circuitry reads the ECC information from a source such as metadata for the data stored in the memory (e.g., with the data and/or in another location). Generally, the ECC information includes a number of bits (e.g., 16, 28, or another number) that can be used, in accordance with a specified algorithm, to correct bit errors of a given size (e.g., one bit)—and possibly detect bit errors of another size (e.g., two bits)—in the data. The processor in memory circuitry then uses the ECC information for correcting errors in the data in the location (step 1302). For this operation, the processor in memory circuitry uses the ECC information in accordance with the specified algorithm to correct bit errors of a given size—i.e., to correct bit errors in the data in the location. The processor in memory circuitry may also detect bit errors of another size—and may trigger a fault or other error handling routine when an uncorrectable error is detected.

In the described implementations, the various operations described for FIG. 13 are performed in the processor in memory circuitry itself, instead of by another entity (e.g., processor 102). The means that the other entity need not be involved with these operations, which reduces the operational load on the other entity, the delay associated with accessing the data, etc. In some implementations, performing the memory scrubbing operations in the processor in memory circuitry can enable these operations to be performed at all—or can enable more memory scrubbing operations than might otherwise be possible—as the processing is performed locally in the high bandwidth memory.

In some implementations, the processor in memory circuitry performs the operations shown in FIG. 13 for each of multiple pieces of data. In other words, although a single piece of data is described for FIG. 13, the processor in memory circuitry can perform the operations for any number of pieces of data. For example, in some implementations, the processor in memory circuitry proceeds through the high bandwidth memory, performing the operations shown in FIG. 13 for each piece of data and/or for specified pieces of data—and may start over with an initial piece of data when all the pieces of data have been processed.

In some implementations, the processor in memory circuitry performs the operations shown in FIG. 13 at specified times in order to avoid interfering with other memory operations (e.g., accesses of data in memory, etc.). For example, the processor in memory circuitry can perform the operations shown in FIG. 13 during idle times, in a specified window/period of time, etc. In some implementations, the processor in memory circuitry performs the operations shown in FIG. 13 for only a subset of pieces of data in the high bandwidth memory at a time—e.g., as many as possible during an idle period, etc. In some implementations, for the operations described in FIG. 13, the processor in memory circuitry includes dedicated and/or purpose-specific circuitry for performing some or all of the operations. In some implementations, however, the processor in memory circuitry includes general purpose circuitry (e.g., instruction execution circuitry, etc.) that is used for performing some or all of the operations described for FIG. 13.

In some implementations, the processor in memory circuitry performs operations for determining locations where migrated data is stored in the high bandwidth memory or the memory. Recall that, in some implementations, control circuitry in the high bandwidth memory, the memory, and/or in another location (e.g., on the processor, etc.) can perform operations for migrating/moving specified data between the high bandwidth memory and the memory. For example, in some implementations, the control circuitry can migrate more frequently accessed or higher priority data from the memory to the high bandwidth memory to increase access speed for the data. These operations are performed at the hardware level, i.e., by the control circuitry, typically without being directly controlled by the operating system or other software entities. In these implementations, the control circuitry keeps a remapping record that identifies where data (i.e., data that may have been migrated) is stored in the high bandwidth memory or memory. The remapping record is typically stored in the faster-access high bandwidth memory, rather than the memory, to enable more rapid accesses of the remapping record. In some implementations, instead of the control circuitry itself performing lookups in the remapping record, which would require the control circuitry to access the data in the memory circuitry in the high bandwidth memory in which the remapping record is stored, the processor in memory circuitry performs the lookups. In other words, in these implementations, the processor in memory circuitry determines locations where migrated data is stored in the high bandwidth memory or the memory using the remapping record. For example, the processor in memory can use an address where the operating system initially stored the data to look up an address to where the data was migrated in the remapping table. In some implementations, the processor in memory circuitry checks the remapping record for each access of data to determine an address where the data is presently stored. Because data may not have been migrated, such a lookup can return the initial/original address where the data was stored in the high bandwidth memory or the memory.

In some implementations, at least one electronic device (e.g., electronic device 100, etc.) uses code and/or data stored on a non-transitory computer-readable storage medium to perform some or all of the operations described herein. More specifically, the at least one electronic device reads code and/or data from the computer-readable storage medium and executes the code and/or uses the data when performing the described operations. A computer-readable storage medium can be any device, medium, or combination thereof that stores code and/or data for use by an electronic device. For example, the computer-readable storage medium can include, but is not limited to, volatile and/or non-volatile memory, including flash memory, random access memory (e.g., eDRAM, RAM, SRAM, DRAM, DDR5 DRAM, etc.), non-volatile RAM (e.g., phase change memory, ferroelectric random access memory, spin-transfer torque random access memory, magnetoresistive random access memory, etc.), read-only memory (ROM), and/or magnetic or optical storage mediums (e.g., disk drives, magnetic tape, CDs, DVDs, etc.).

In some implementations, one or more hardware modules perform the operations described herein. For example, the hardware modules can include, but are not limited to, one or more central processing units (CPUs)/CPU cores, graphics processing units (GPUs)/GPU cores, application-specific integrated circuit (ASIC) chips, field-programmable gate arrays (FPGAs), quantum processors, compressors or encoders, encryption functional blocks, compute units, embedded processors, accelerated processing units (APUs), controllers, requesters, completers, network communication links, and/or other functional blocks. When circuitry (e.g., integrated circuit elements, discrete circuit elements, etc.) in such hardware modules is activated, the circuitry performs some or all of the operations. In some implementations, the hardware modules include purpose-specific or dedicated circuitry that performs the operations “in hardware” and without executing instructions. In some implementations, the hardware modules include general purpose circuitry such as execution pipelines, compute or processing units, etc. that, upon executing instructions (e.g., program code, firmware, etc.), performs the operations.

In some implementations, a data structure representative of some or all of the functional blocks and circuit elements described herein (e.g., electronic device 100, or some portion thereof) is stored on a non-transitory computer-readable storage medium that includes a database or other data structure which can be read by an electronic device and used, directly or indirectly, to fabricate hardware including the functional blocks and circuit elements. For example, the data structure may be a behavioral-level description or register-transfer level (RTL) description of the hardware functionality in a high-level design language (HDL) such as Verilog or VHDL. The description may be read by a synthesis tool which may synthesize the description to produce a netlist including a list of transistors/circuit elements from a synthesis library that represent the functionality of the hardware including the above-described functional blocks and circuit elements. The netlist may then be placed and routed to produce a data set describing geometric shapes to be applied to masks. The masks may then be used in various semiconductor fabrication steps to produce a semiconductor circuit or circuitry (e.g., integrated circuitry) corresponding to the above-described functional blocks and circuit elements. Alternatively, the database on the computer accessible storage medium may be the netlist (with or without the synthesis library) or the data set, as desired, or Graphic Data System (GDS) II data.

In this description, variables or unspecified values (i.e., general descriptions of values without particular instances of the values) are represented by letters such as N and M. As used herein, despite possibly using similar letters in different locations in this description, the variables and unspecified values in each case are not necessarily the same, i.e., there may be different variable amounts and values intended for some or all of the general variables and unspecified values. In other words, particular instances of N and any other letters used to represent variables and unspecified values in this description are not necessarily related to one another.

The expression “et cetera” or “etc.” as used herein is intended to present an and/or case, i.e., the equivalent of “at least one of” the elements in a list with which the etc. is associated. For example, in the statement “the electronic device performs a first operation, a second operation, etc.,” the electronic device performs at least one of the first operation, the second operation, and other operations. In addition, the elements in a list associated with an etc. are merely examples from among a set of examples—and at least some of the examples may not appear in some implementations.

The foregoing descriptions of implementations have been presented only for purposes of illustration and description. They are not intended to be exhaustive or to limit the implementations to the forms disclosed. Accordingly, many modifications and variations will be apparent to practitioners skilled in the art. Additionally, the above disclosure is not intended to limit the implementations. The scope of the implementations is defined by the appended claims.

What is claimed is:

1. An electronic device, comprising:
a processor; and
a memory separate from the processor, the memory including:
memory circuitry including a plurality of locations that are used for storing cache blocks for a cache memory; and
processor in memory circuitry configured to perform operations for handling the cache blocks in the memory circuitry.

2. The electronic device of claim 1, wherein, when performing the operations for handling the cache blocks in the memory circuitry, the processor in memory circuitry is configured to:
perform cache lookups to determine whether cache blocks to be accessed by the processor are present in the locations in the memory circuitry.

3. The electronic device of claim 1, wherein, when performing the operations for handling the cache blocks in the memory circuitry, the processor in memory circuitry is configured to:
when cache blocks to be accessed by the processor are present in the locations in the memory circuitry, perform the accesses of the cache blocks.

4. The electronic device of claim 1, wherein, when performing the operations for handling the cache blocks in the memory circuitry, the processor in memory circuitry is configured to:
when cache blocks to be accessed by the processor are not present in the locations in the memory circuitry, determine victim locations in the memory circuitry to be used for storing the cache blocks and invalidate the victim locations.

5. The electronic device of claim 1, wherein, when performing the operations for handling the cache blocks in the memory circuitry, the processor in memory circuitry is configured to:
upon accessing one or more of the cache blocks at one or more of the locations in the memory circuitry, update access information associated with the one or more of the locations in the memory circuitry.

6. The electronic device of claim 1, wherein, when performing the operations for handling the cache blocks in the memory circuitry, the processor in memory circuitry is configured to:
determine cache blocks that are more likely to be accessed and swap the cache blocks that are more likely to be accessed into specified locations in the memory circuitry.

7. The electronic device of claim 1, wherein, when performing the operations for handling the cache blocks in the memory circuitry, the processor in memory circuitry is configured to:
determine one or more of the cache blocks stored in one or more of the locations in the memory circuitry to be compressed and compress data in the one or more of the cache blocks.

8. The electronic device of claim 1, wherein, when performing the operations for handling the cache blocks in the memory circuitry, the processor in memory circuitry is configured to:
predict one or more dead cache blocks stored in one or more of the locations in the memory circuitry that are unlikely to be accessed and invalidate the one or more dead cache blocks in the one or more of the locations in the memory.

9. The electronic device of claim 1, wherein the processor in memory circuitry performs the operations for handling the cache blocks in the memory circuitry without communicating the cache blocks and/or metadata associated with the cache blocks to the processor.

10. An electronic device, comprising:
a processor; and
a high bandwidth memory separate from the processor, the high bandwidth memory including:
memory circuitry including a plurality of locations, the plurality of locations including locations used as an operating system visible memory; and
processor in memory circuitry configured to perform operations for handling data in the locations used as the operating system visible memory.

11. The electronic device of claim 10, wherein the operations for handling the data include memory scrubbing operations for correcting bit errors in data in one or more of the locations used as the operating system visible memory using error correction information stored in respective medadata.

12. The electronic device of claim 10, wherein the operations for handling the data include lookup operations in a remapping record to determine locations in the high bandwidth memory or in a main memory where data to be located is stored.

13. A method for using a memory in an electronic device that includes the memory and a processor separate from the memory, the memory including memory circuitry including a plurality of locations and processor in memory circuitry, and the method comprising:
using at least some of the locations in the memory for storing cache blocks for a cache memory; and
performing, by the processor in memory circuitry, operations for handling the cache blocks in the memory circuitry.

14. The method of claim 13, wherein performing the operations for handling the cache blocks in the memory circuitry includes:
performing cache lookups to determine whether cache blocks to be accessed by the processor are present in locations in the memory circuitry.

15. The method of claim 13, wherein performing the operations for handling the cache blocks in the memory circuitry includes:
when cache blocks to be accessed by the processor are present in the locations in the memory circuitry, performing the accesses of the cache blocks.

16. The method of claim 13, wherein performing the operations for handling the cache blocks in the memory circuitry includes:
when cache blocks to be accessed by the processor are not present in the locations in the memory circuitry, determining victim locations in the memory circuitry to be used for storing the cache blocks and invalidating the victim locations.

17. The method of claim 13, wherein performing the operations for handling the cache blocks in the memory circuitry includes:
upon accessing one or more of the cache blocks at one or more of the locations in the memory circuitry, updating access information associated with the one or more of the locations in the memory circuitry.

18. The method of claim 13, wherein performing the operations for handling the cache blocks in the memory circuitry includes:
determining cache blocks that are more likely to be accessed and swapping the cache blocks that are more likely to be accessed into specified locations in the memory circuitry.

19. The method of claim 13, wherein performing the operations for handling the cache blocks in the memory circuitry includes:
determining one or more of the cache blocks stored in one or more of the locations in the memory circuitry to be compressed and compressing data in one or more of the cache blocks.

20. The method of claim 13, wherein performing the operations for handling the cache blocks in the memory circuitry includes:
predicting one or more dead cache blocks stored in one or more of the locations in the memory circuitry that are unlikely to be accessed and invalidating the one or more dead cache blocks in the one or more of the locations in the memory.

21. The method of claim 13, wherein the PIM performs the operations for handling the cache blocks in the memory circuitry without communicating the cache blocks and/or metadata associated with the cache blocks to the processor.

22. A method for using a high bandwidth memory in an electronic device that includes the high bandwidth memory and a processor separate from the high bandwidth memory, the high bandwidth memory including memory circuitry with a plurality of locations and processor in memory circuitry, and the method comprising:
using at least some of the locations in the high bandwidth memory as an operating system visible memory; and
performing, by the processor in memory circuitry, operations for handling data in the locations used as the operating system visible memory.

23. The method of claim 22, wherein the operations for handling the data include memory scrubbing operations for correcting bit errors in data in one or more of the locations used as the operating system visible memory using error correction information stored in respective metadata.

24. The method of claim 22, wherein the operations for handling the data include lookup operations in a remapping record to determine locations in the high bandwidth memory or in a main memory where data to be located is stored.
